(19) United States
(12) Patent Application Publication
(10) Pub. No.: US 2011/0035679 A1
(43) Pub. Date: Feb. 10, 2011

(54) COOPERATIVE TASK SUPPORTING SYSTEM AND SERVER

(75) Inventor: Masanobu Nishitani, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/849,747

(22) Filed: Aug. 3, 2010

(30) Foreign Application Priority Data
Aug. 5, 2009 (JP) 2009-182393

(51) Int. Cl. G06F 3/01; G06F 15/16

(52) U.S. Cl. 715/751

(57) ABSTRACT

Provided is a cooperative task supporting system having a plurality of clients, which are to be used by a plurality of users, and a server and supporting a cooperative task of the plurality of users of the plurality of clients, wherein the server includes: a part information storage unit which stores part information including attribute information of a predetermined object corresponding to a part, which is to be displayed on a screen of the client of the user participating in the cooperative task, and address information on the object; and a transmitting unit which transmits the part information to the client of the user participating in the cooperative task, and wherein the client includes: a receiving unit which receives the part information; and a display control unit which allows the part to be displayed on the screen based on the part information.

### BACKGROUND

1. Technical Field

The present invention relates to a cooperative task supporting system and a server for supporting cooperative task by using a plurality of clients connected to a network.

2. Related Art

In the related art, there is known a remote conference system which is used by a plurality of users accessing a server through a network.

In such a remote conference system, for example, the same screen is displayed for a plurality of clients. In other words, the entire screen is shared. In this case, since data transmission amount is increased in order to share the entire screen, the network for connecting the clients is required to have a wide bandwidth. On the contrary, for example, there is disclosed a method of transmitting and receiving only the updated area of the screen while checking the process status of the transmitting side or the load information of the receiving side (refer to JP-A-2004-259163).

In addition, there is also disclosed a technology of combining screens of clients of participants on a server and transmitting to the clients of the users, thereby allowing the screen written in each of the clients to be displayed in each of the clients in a cooperative task system of performing a cooperative task using the screen shared by the plurality of the participants (refer to JP-A-2006-31359).

However, in the technology disclosed in JP-A-2004-259163, since the screen display is simply shared, each participant may not edit displayed texts, figures, or the like. In other words, each participant may not perform a cooperative task through data sharing.

On the contrary, in the technology disclosed in JP-A-2006-31359, the edited screen is shared by the clients, so that the cooperative task may be performed. However, since the server side combines the screen of the contents of the clients and transmits the combined screen to all of the clients, there is a problem in that the load on the server is greatly increased.

### SUMMARY

An advantage of some aspects of the invention is to provides a technology capable of suppressing load to a server and allowing a plurality of users to easily perform a cooperative task.

According to a first aspect of the invention, there is provided a cooperative task supporting system having a plurality of clients, which are to be used by a plurality of users, and a server and supporting a cooperative task of the plurality of users of the plurality of clients, wherein the server includes: a part information storage unit which stores part information including attribute information of a predetermined object corresponding to a part, which is to be displayed on a screen of the client of the user participating in the cooperative task, and address information on the object; and a transmitting unit which transmits the part information to the client of the user participating in the cooperative task, and wherein the client includes: a receiving unit which receives the part information; and a display control unit which allows the part to be displayed on the screen based on the part information.

According to such a cooperative task supporting system, the part information of the part which is to be displayed on the screen of the client is transmitted to the client of the user participating in the cooperative task, and the client allows the part to be displayed on the screen based on the part information. Therefore, it is not necessary to configure the screen in the server, and it is possible to reduce the load on the server.

In the above cooperative task supporting system, the server may further include a to-be-added part information receiving unit which receives, from the client, to-be-added part information including attribute information and address information corresponding to a to-be-added part, which is to be newly added and displayed on the screen of the client, wherein the transmitting unit transmits the to-be-added part information to the client of the user participating in the cooperative task, and the receiving unit of the client may receives the to-be-added part information, and wherein the display control unit allows the to-be-added part to be displayed on the screen based on the to-be-added part information. According to such a cooperative task supporting system, in the case where there is a to-be-added part which is to be newly added on the screen, by transmitting the to-be-added part information to each client, the to-be-added part information is displayed on the screen of each client. Therefore, in the case where the to-be-added part is to be displayed on the screen, by transmitting the to-be-added part information to each client, the server allows each client to display the screen where the to-be-added part is added, so that it is possible to reduce the amount of data which is to be transmitted to each client.

In the above cooperative task supporting system, the server may further include a to-be-removed part information receiving unit which receives, from the client, to-be-removed part information specifying a to-be-removed part, which is to be removed from the screen of the client, the transmitting unit may transmit the to-be-removed part information to the client of the user participating in the cooperative task, the receiving unit of the client may receive the to-be-removed part information, and the display control unit may allow the to-be-removed part to be removed from the screen based on the to-be-removed part information. According to such a cooperative task supporting system, in the case where there is a to-be-removed part which is to be removed from the screen, by transmitting the to-be-removed part information to each client, the screen where the to-be-removed part is removed is displayed in each client. Therefore, by transmitting the to-be-removed part information to each client, the server allows each client to display the screen where the to-be-removed part is removed, so that it is possible to reduce the amount of data which is to be transmitted to each client.

In the above cooperative task supporting system, the server may further include a to-be-changed part information receiving unit which receives, from the client, to-be-changed part information indicating an object indicated by a part of the screen of the client is changed, the transmitting unit may transmit the to-be-changed part information to the client of the user participating in the cooperative task, the receiving unit of the client may receive the to-be-changed part information, and the client may further include: a client part information storage unit which stores the part information; and a part information changing unit which updates and stores the part information based on the to-be-changed part information. According to such a cooperative task supporting system, in the case of changing the object indicated by the part, by transmitting the to-be-changed part information to each client, the part information in each client is updated. Therefore, by transmitting only the to-be-changed part information to each client, the server may appropriately update the part information of the part, so that it is possible to reduce the amount of data which is to be transmitted to each client.

In the above cooperative task supporting system, the client may further include a layout information storage unit which stores layout information specifying a layout position on the screen corresponding to the attribute information indicated by a part, and the display control unit may determine the layout position of the part on the screen based on the attribute information of the part information and the layout information. According to such a cooperative task supporting system, in the client, the layout position of the part on the screen is determined based on the attribute information of the part information and the layout information, so that the screen display is performed. Therefore, the appropriate layout information is allowed to be stored in each client, so that it is possible to display the image where the appropriate part layout is performed in the client.

In the above cooperative task supporting system, the client may further include a client side data acquisition unit which accesses an access site corresponding to the address information of the part information to acquire a data from the access site. According to such a cooperative task supporting system, the data (data, program data, and the like) may be appropriately acquired from the access site corresponding to the address information of the part information.

In the above cooperative task supporting system, the object indicated by the part may be a data, the display control unit may display the part information as an icon on the screen, and the client side data acquisition unit may acquire the data from the access site according to indication manipulation on the icon. According to such a cooperative task supporting system, by performing the indication manipulation on the icon with respect to the client, the corresponding data may be easily acquired.

In the above cooperative task supporting system, the server may include: a server-side data acquisition unit which, in the case where the object indicated by the part information received from the client is a data, acquires the data based on the address information; a shared data storage unit which stores the acquired data; and an updating unit which updates the address information of the part information into an address of the data in the shared data storage unit, the transmitting unit may transmit the updated part information to the client of the user participating in the cooperative task, and in the case of receiving an access instruction for the object indicted by the part information, the client side data acquisition unit may acquire the data from the shared data storage unit of the server indicated by the address information. According to such a cooperative task supporting system, the data which may be probably transmitted to each client may be stored in the shared data storage unit of the server, so that the data may be appropriately managed.

In the above cooperative task supporting system, the object indicated by the part may be an application, the client side data acquisition unit may acquire a program data of the application from the access site, and the client may further include a program execution unit which executes the program data. According to such a cooperative task supporting system, the application program indicated by the part may be acquired from the access site and appropriately executed.

In the above cooperative task supporting system, storage site address information of a storage site storing a driver program of a device of the object may be included in the attribute information of the object, the client may include: a driver acquisition unit which acquires the driver program of the device based on the storage site address information; and an installation unit which installs the acquired driver program. According to such a cooperative task supporting system, the driver program of the device of the object indicated by the part may be appropriately acquired and installed.

According to a second aspect of the invention, there is provided a server for supporting a cooperative task, including: a part information storage unit which stores part information including attribute information of a predetermined object corresponding to a part, which is to be displayed on a screen of a client of a user participating in the cooperative task, and address information on the object; and a transmitting unit which transmits the part information to the client of the user participating in the cooperative task. According to such a server, the part information of the part which is to be displayed on the screen of the client is transmitted to the client of the user participating in the cooperative task. Therefore, it is not necessary to configure the screen in the server, and it is possible to reduce the load on the server.

### BRIEF DESCRIPTION OF THE DRAWINGS

The invention will be described with reference to the accompanying drawings, wherein like numbers reference like elements.

FIG. 1 is a diagram illustrating a configuration of a conference system according to an embodiment of the invention.

FIG. 2 is a diagram illustrating a functional configuration of a conference server according to an embodiment of the invention.

FIG. 3 is a diagram illustrating a configuration of user information in a user information database according to an embodiment of the invention.

FIG. 4 is a diagram illustrating a functional configuration of a management server according to an embodiment of the invention.

FIGS. 5A to 5C are diagrams illustrating GUI part information according to an embodiment of the invention.

FIGS. 6A to 6C are diagrams illustrating an attribute of GUI part information according to an embodiment of the invention.

FIG. 7 is a diagram illustrating GUI part basic information according to an embodiment of the invention.

FIG. 8 is a diagram illustrating a functional configuration of a client according to an embodiment of the invention.

FIG. 9 is a diagram illustrating management of a screen of a client according to an embodiment of the invention.

FIG. 10 is a diagram illustrating a layout of a panel in a screen according to an embodiment of the invention.

FIG. 11 is a diagram illustrating layout setting information according to an embodiment of the invention.

FIG. 12 is a diagram illustrating panel setting information according to an embodiment of the invention.

FIG. 13 is a flowchart of a conference participation and GUI display process in a client according to an embodiment of the invention.

FIG. 14 is a flowchart of a delivery process at the time of participation of a management server according to an embodiment of the invention.

FIG. 15 is a flowchart of a GUI part information transmission management process of a management server according to an embodiment of the invention.

FIG. 16 is a flowchart of a user verification process of a conference server according to an embodiment of the invention.

FIG. 17 is a sequence diagram at the time of a first user's participation according to an embodiment of the invention.

FIGS. 18A and 18B are diagrams illustrating GUI part information at the time of the user's participation according to an embodiment of the invention.

FIG. 19 is a sequence diagram at the time of a next user's participation according to an embodiment of the invention.

FIGS. 20A to 20D are diagrams illustrating GUI part information at the time of the next user's participation according to an embodiment of the invention.

FIG. 21 is a sequence diagram at the time of adding a GUI part according to an embodiment of the invention.

FIGS. 22A to 22E are diagrams illustrating GUI part information at the time of adding a GUI part according to an embodiment of the invention.

FIG. 23 is a sequence diagram at the time of changing a GUI part according to an embodiment of the invention.

FIGS. 24A to 24E are diagrams illustrating GUI part information at the time of changing a GUI part according to an embodiment of the invention.

FIG. 25 is a sequence diagram at the time of removing a GUI part according to an embodiment of the invention.

FIGS. 26A to 26E are diagrams illustrating GUI part information at the time of removing a GUI part according to an embodiment of the invention.

### DESCRIPTION OF EXEMPLARY EMBODIMENTS

Hereinafter, embodiments of the invention will be described with reference to the drawings. The embodiments hereinafter described do not limit the invention set forth as the claims, but all components of the embodiments and combinations thereof are not necessary for the solving unit of the invention.

First, as an example of a cooperative task supporting system according to an embodiment of the invention, a conference system is described.

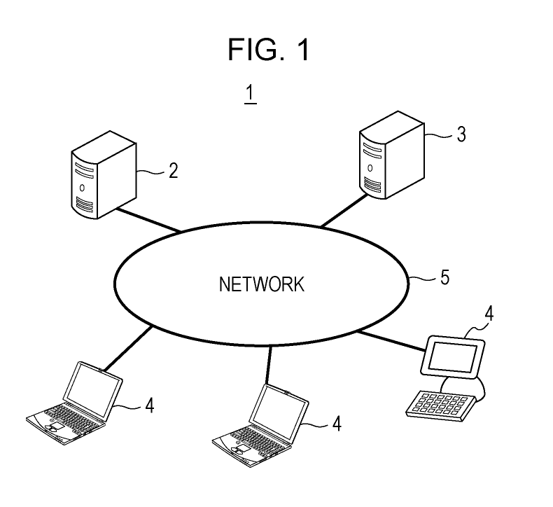

FIG. 1 is a diagram illustrating a configuration of a conference system according to the embodiment of the invention.

The conference system 1 includes a conference server 2, a management server 3, and a plurality of clients 4 that may be used by a plurality of users, which are connected to each other through a network 5. Each of the conference server 2 and the management server 3 is configured, for example, by a PC (Personal Computer). Each of the clients 4 is configured, for example, by a PC. The network 5 may be a LAN (Local Area Network) or a WAN (Wide Area Network) and may include the Internet. In addition, in the embodiment, the network 5 includes the Internet, so that various servers (not shown) connected to the Internet may be allowed to be accessed.

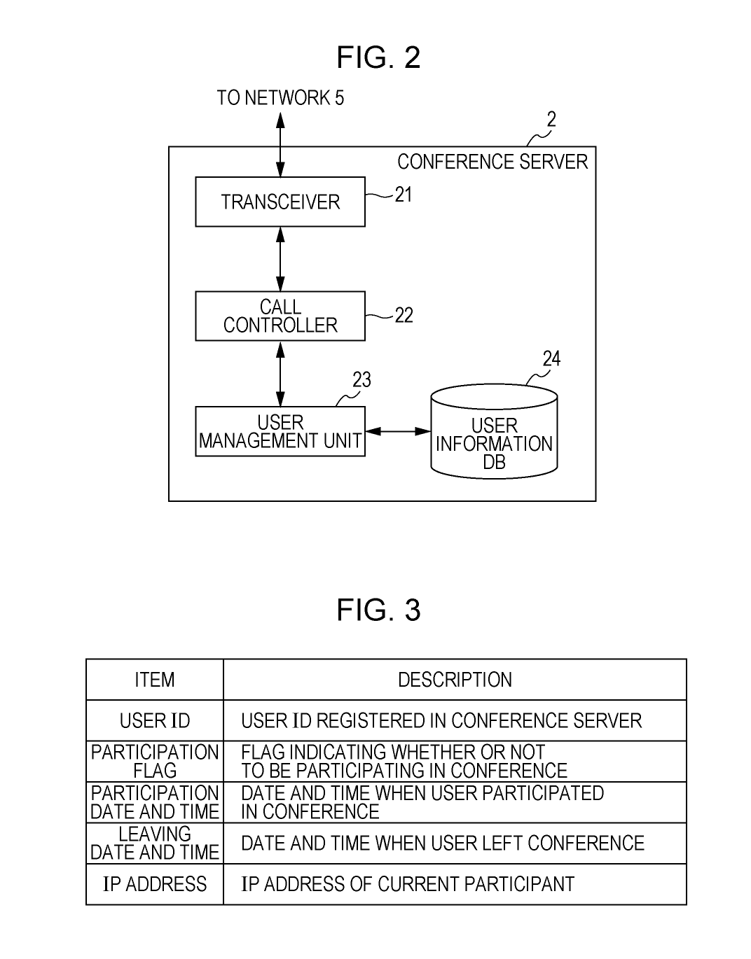

FIG. 2 is a diagram illustrating a functional configuration of the conference server according to the embodiment of the invention.

The conference server 2 is a server which performs participant (user) management for a conference (cooperative task) and call control and has functions equivalent to a general conference server. The conference server 2 includes a transceiver 21, a call controller 22, a user management unit 23, and a user information database (user information DB) 24. The transceiver 21 performs transmitting and receiving various data to and from other apparatuses (the management server 3, the client 4, or the like) through the network 5. The call controller 22 performs the call control. The call controller 22 performs the call control, for example, according to the existing protocol such as an SIP (Session Initiation Protocol) or H.323. In the case where there is a query about the user, the user management unit 23 provides user information (position information (IP address) of the client 4 of the user and authority information) or verifies whether or not the user is a user whose participation in the cooperative task is authenticated and provides the result. The user information DB 24 stores the user information.

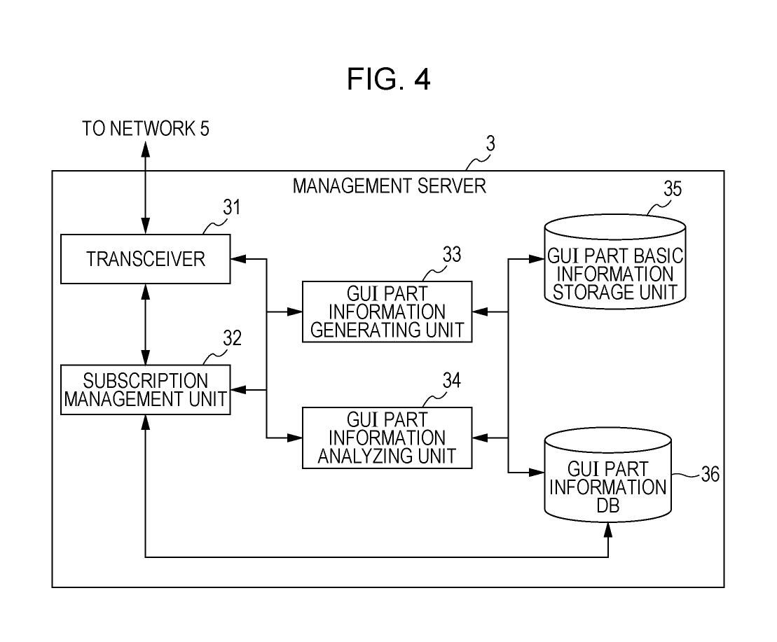

FIG. 3 is a diagram illustrating a configuration of user information in a user information database according to an embodiment of the invention.

The user information stored in the user information DB 24 includes a user ID, a participation flag, a participation date and time, a leaving date and time, and an IP (Internet Protocol) address. The user ID is an ID of a user who is registered in the conference server 2, in other word, whose participation in the conference is admitted. The participation flag is a flag indicating whether or not the corresponding user is participating in the conference. The participation date and time is a data and time when the user participated in the conference. The leaving date and time is a data and time when the user left the conference. The IP address is an IP address of the client 4 which the corresponding user is using.

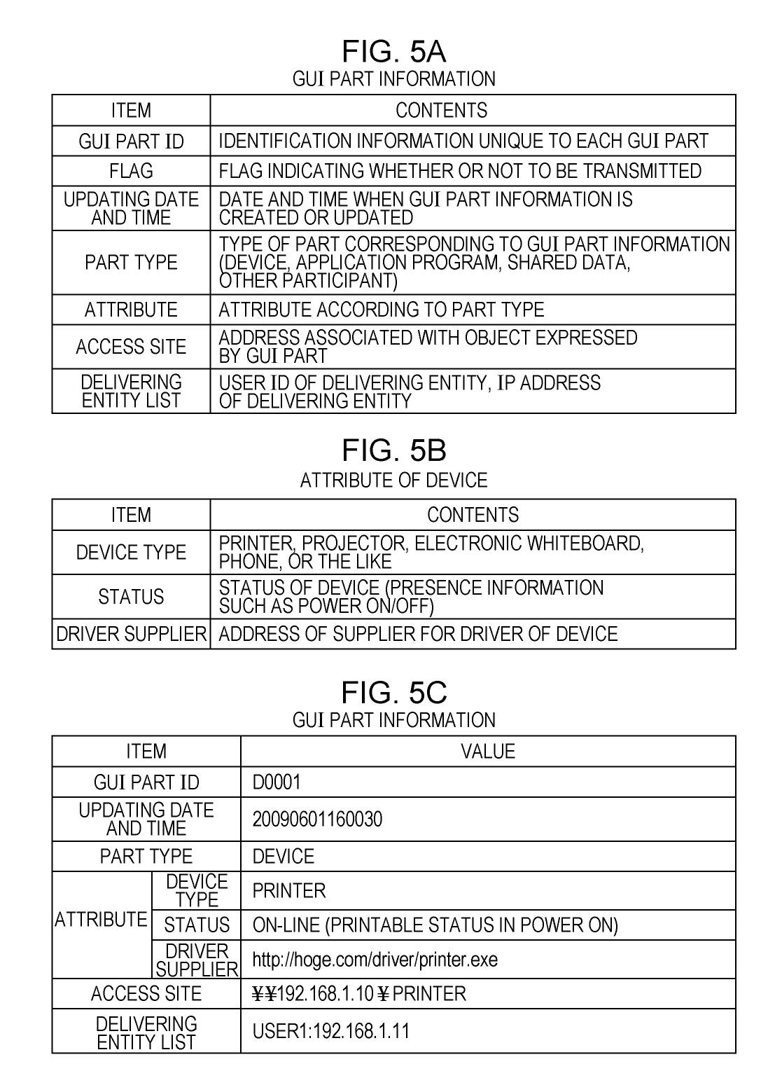

FIG. 4 is a diagram illustrating a functional configuration of a management server according to an embodiment of the invention.

The management server 3 performs managing information (GUI part information: part information) of GUI parts which are used in the conference and performs delivering the GUI part information, delivering changed GUI part information, delivering to-be-removed GUI part information, and the like to the client 4 of the user. The management server 3 includes a transceiver 31 and a subscription management unit 32 as examples of a transmitting unit, a to-be-added part information receiving unit, a to-be-removed part information receiving unit, and a to-be-changed part information receiving unit; a GUI (Graphical User Interface) part information generating unit 33, a GUI part information analyzing unit 34, and a GUI part basic information storage unit 35 as examples of a server-side data acquisition unit and an updating unit; and a GUI part information database (GUI part information DB) 36 as an example of a part information storage unit.

The transceiver 31 performs receiving and transmitting of various data to and from other apparatuses (conference server 2, client 4, and the like) through the network 5. The subscription management unit 32 performs a process of querying the conference server 2 whether or not a user can participate in a conference, a process of managing a user of a delivery site for the GUI part information, or the like. The GUI part information generating unit 33 generates the GUI part information to be transmitted to the client 4. The GUI part information analyzing unit 34 analyzes the GUI part information transmitted from the client 4 and determines whether the GUI part information is the GUI part information (to-be-added GUI part information: to-be-added part information) indicating addition of a new part, the GUI part information (to-be-changed GUI part information: to-be-changed part information) indicating change in GUI part information corresponding to a part, or the GUI part information (to-be-removed GUI part information: to-be-removed part information) indicating removing of a part.

The GUI part information DB 36 manages (stores or the like) the GUI part information that is to be transmitted to each client 4.

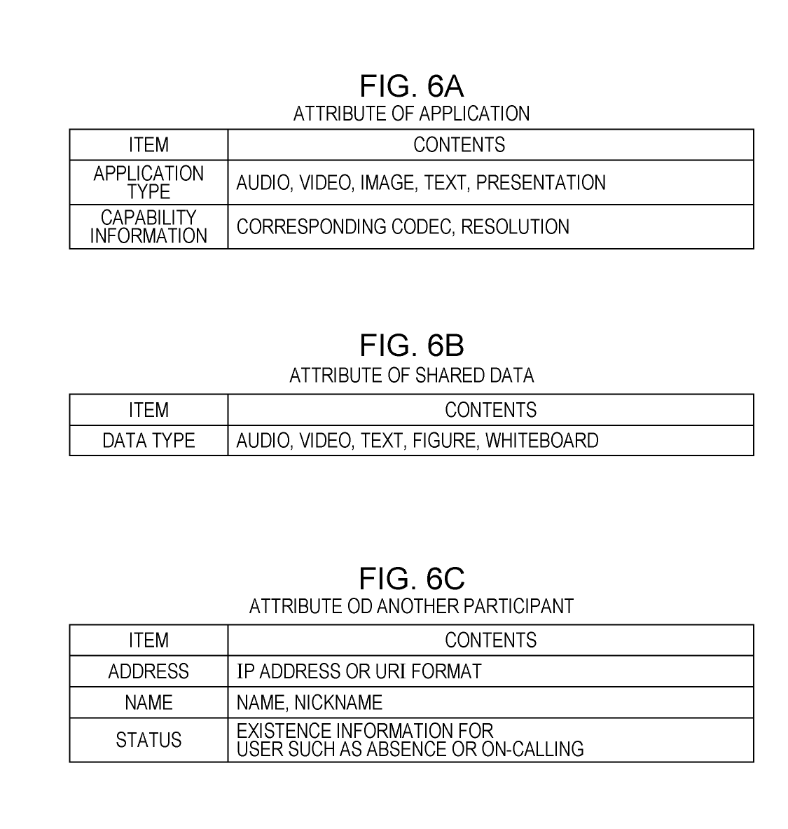

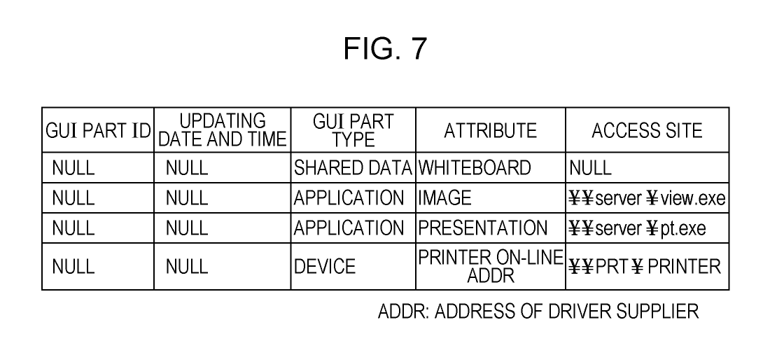

FIGS. 5A to 5C are diagrams illustrating GUI part information according to an embodiment of the invention. FIGS. 6A to 6C are diagrams illustrating an attribute of the GUI part information according to the embodiment of the invention.

FIG. 5A illustrates a basic structure of the GUI part information. FIG. 5B illustrates an attribute in the case where the part type (object indicated by a part) is a device. FIG. 5C illustrates an example of specific GUI part information in the case where the part type is a device. FIG. 6A illustrates an attribute in the case where the part type is an application. FIG. 6B illustrates an attribute in the case where the part type is a shared data. FIG. 6C illustrates an attribute in the case where the part type is anther participant.

The GUI part information that is managed by the GUI part information DB 36, as illustrated FIG. 5A, includes a GUI part ID, a flag, an updating date and time, a part type, an attribute, an access site, and a delivering entity list. The GUI part ID is identification information uniquely indicating each GUI part. The flag is a flag indicating whether or not the corresponding GUI part information is to be transmitted. The updating date and time is a date and time when the GUI part information is created or updated. The part type is a type of an object expressed by the part corresponding to the GUI part information. As examples of the object expressed by the part, there are devices such as a printer or a projector, an application program (application), a shared data, another participant (another user), and the like. The attribute is an attribute according to the part type. Detailed examples of the attribute according to the part type are described later. The access site is an address associated with the object expressed by the GUI part, for example, an address indicating an actual entity of the object expressed by the GUI part. As examples of the notation format of the access site, for example, there are URI (Uniform Resource Identifier), UNC (Universal Naming Convention), and the like.

The URI format is a format describing a location of information resources existing on a network, and for example, the URL (Uniform Resource Locator) indicating an address on the Internet is included therein. More specifically, for example, in the case of HTTP (Hypertext Transfer Protocol), the format is described like “http://192.168.1.10/printer/”. In the case of SIP, the format is described like “sip:user1@192.168.1.10”. In the case of a file protocol, the format is described like “file:///C:Temp/App.exe”. In addition, in the case where the type is a shared data, since the shared data is managed on the management server 3, the format is described like, for example, “http://server/share/0001”. In the above case, “share” is a folder name of a folder which stores the shared data in the shared server 3. The numerical portion following the “share” denotes a GUI part ID. In addition, in the case where the type is a device and the type of the device is a printer, for example, by using IPP (Internet Printing Protocol), a port number and a printer name may be described after the IP address like “http://192.168.1.10:631/PRINTER”.

The UNC format is a description format for indicating resources (locations of devices, files, and directories) on a network in a dedicated Windows (registered trade mark) OS network environment (a Microsoft (registered trade mark) network). More specifically, for example, in the case of a file (including an execution file), the format is described like “\\192.168.1.10\File.ppt”. In the case of a printer, the format is described like “\\192.168.1.10\PRINTER”.

The delivering entity list is a list of users who delivers the corresponding GUI part information, and the user ID of the delivery site and the IP address are included therein.

In the case where the part type is the device, the attribute is illustrated in FIG. 5B. In other words, the attribute includes a device type, a status, and a driver supplier. The device type indicates a type of the device, and for example, is set with a printer, a projector, an electronic whiteboard, a phone, or the like. The status is a status of the device, and for example, is set with existence information such as power ON/OFF state or the like. The driver supplier is an address of a supplier for a driver program (device driver program) of the corresponding device.

In the case where the part type is the application, the attribute is illustrated in FIG. 6A. In other words, the attribute includes an application type and capability information. The application type is a type of the application, and for example, is set with audio, video, image, text, presentation, or the like. The capability information is information on the capability of the application, and for example, is set with information of a corresponding codec, information of a corresponding resolution, or the like.

In the case where the part type is the shared data, the attribute is illustrated in FIG. 6B. In other words, the attribute includes a data type. The data type indicates a type of data, and for example, is set with audio, video, text, figure, whiteboard, or the like.

In the case where the part type is another participant, the attribute is illustrated in FIG. 6C. In other words, the attribute includes an address, a name, and a status. The address is an IP address of a client 4 of a user or an URI format address. The name is a name or a nickname of a user. The status is existence information for a user, and for example, is set with absence, busy, or the like.

The GUI part basic information storage unit 35 stores the GUI part basic information, that is, a templete for generating basic GUI part information that is to be transmitted to each client 4.

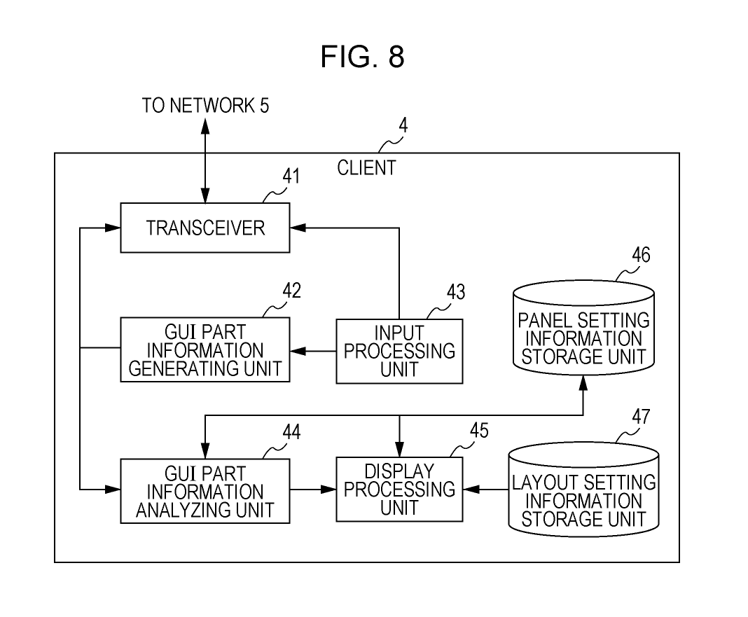

FIG. 7 is a diagram illustrating GUI part basic information according to an embodiment of the invention.

The GUI part basic information includes a GUI part ID, an updating date and time, a GUI part type, an attribute, and an access site. Although each of the contents is the same as that of the GUI part information, the items in the GUI part basic information, which are not yet determined until the GUI part information is actually generated, are set to null. In the embodiment, all of the GUI part ID and the updating date and time are set to null, and, in the case where the part type is a shared data, the access site is also set to null.

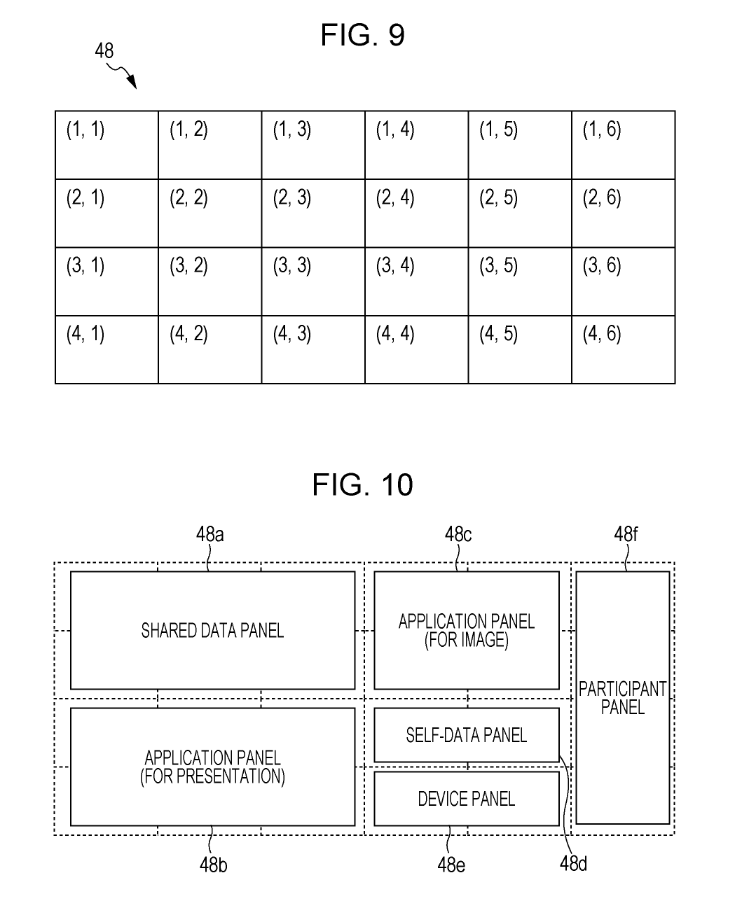

FIG. 8 is a diagram illustrating a functional configuration of a client according to an embodiment of the invention.

The client 4 includes a transceiver 41, a GUI part information generating unit 42, and an input processing unit 43 as an example of a receiving unit; a GUI part information analyzing unit 44 as examples of a driver acquisition unit, an installation unit, a client side data acquisition unit, and a part information changing unit; and a display processing unit 45, a panel setting information storage unit 46, and a layout setting information storage unit 47 as examples of a display control unit and a program execution unit. The layout information storage unit is configured with a panel setting information storage unit 46 and a layout setting information storage unit 47.

The transceiver 41 performs receiving and transmitting of various data to and from other apparatuses (conference server 2, management server 3, and the like) through the network 5. The input processing unit 43 receives various types of input by user's manipulation on an input unit such as a keyboard or a mouse (not shown). In the embodiment, the input processing unit 43 receives an input of GUI part information of a to-be-newly-added GUI part, an instruction of selection of a to-be-removed GUI part, an instruction of selection of a to-be-changed GUI part and an input of changed contents. The GUI part information generating unit 42 generates the GUI part information according to the input of the input processing unit 43. As examples of the generated GUI part information, there are to-be-added GUI part information indicating addition of a new GUI part, to-be-changed GUI part information indicating change in the GUI part, and to-be-removed GUI part information indicating a to-be-removed GUI part. The GUI part information analyzing unit 44 analyses the GUI part information transmitted from the management server 3 and determines whether the GUI part information received by the transceiver 41 is the to-be-added GUI part information, the to-be-changed GUI part information, or the to-be-removed GUI part information. The display processing unit 45 performs displaying a screen on a display apparatus (not shown) based on the analysis result of the GUI part information analyzing unit 44. Detailed process will be described later. The layout setting information storage unit 47 stores layout setting information indicating a layout position of the panel which is disposed on the screen. The panel setting information storage unit 46 stores panel setting information indicating GUI part and shape thereof displayed in the panel arranged on the screen.

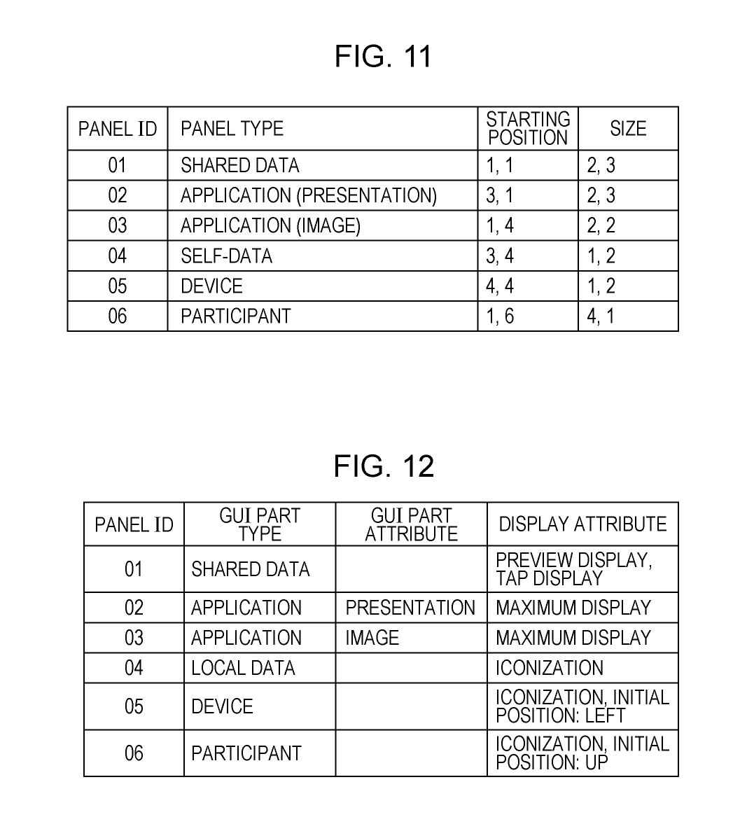

FIG. 9 is a diagram illustrating management of a screen of a client according to an embodiment of the invention.

The screen 48 for conference in the client 4 is managed to be, for example, with 4×6 grids as illustrated in FIG. 9. A coordinate (row and column) is defined at each grid.

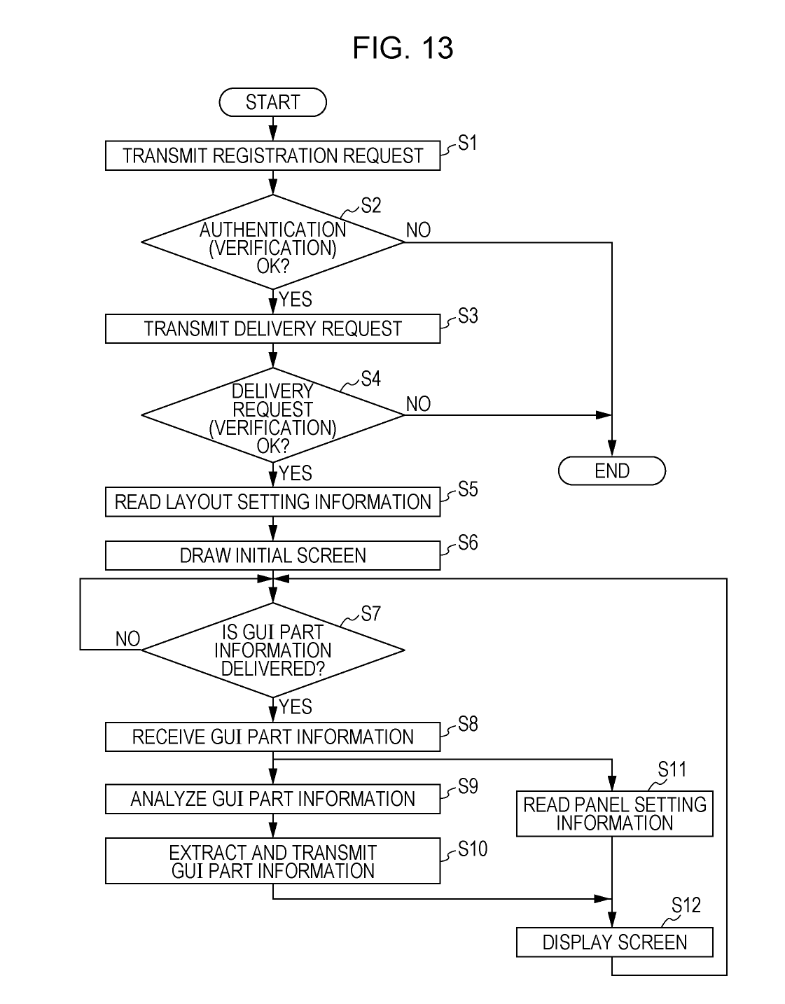

FIG. 10 is a diagram illustrating a layout of a panel in a screen according to an embodiment of the invention.

In the embodiment, as illustrated in FIG. 10, a shared data panel 48a, an application panel (for presentation) 48b, an application panel (for image) 48c, a self-data panel 48d, a device panel 48e, and a participant panel 48f are arranged on the screen.

A part of a shared data is displayed on the shared data panel 48a. A part of a presentation application is displayed on the application panel (for presentation) 48b. A part of an image application is displayed on the application panel (for image) 48c. A local data is displayed on the self-data panel 48d. A part of a device is displayed on the device panel 48e. A part indicating a participant is displayed on the participant panel 48f.

The layout of the panel and the display of the part on the panel in the screen are performed by the display processing unit 45 based on the layout setting information and the panel setting information.

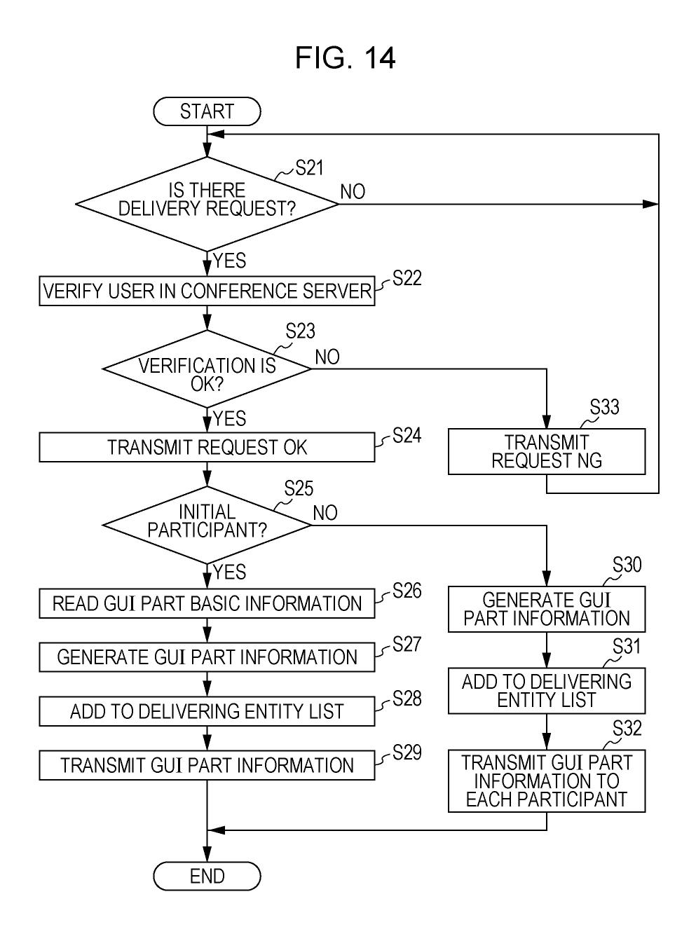

FIG. 11 is a diagram illustrating layout setting information according to an embodiment of the invention.

The layout setting information includes a panel ID, a panel type, a starting position, and a size. The panel ID is an ID uniquely indicating a panel. The panel type is a type of information displayed on a panel. The starting position denotes a display starting position of a panel in the screen 48. In the embodiment, as the display starting position, a coordinate of a grid located at the upper left portion of the panel is used. The size denotes a size of a panel. In the embodiment, the size denotes a range of the grid where the panels are arranged (row range and column range). For example, the panel of which the panel ID is “02” is an application panel (for presentation); the upper left portion of the panel is grid “3, 1”, and the panel is displayed in the range of the 2×3 (rowxcolumn) grid.

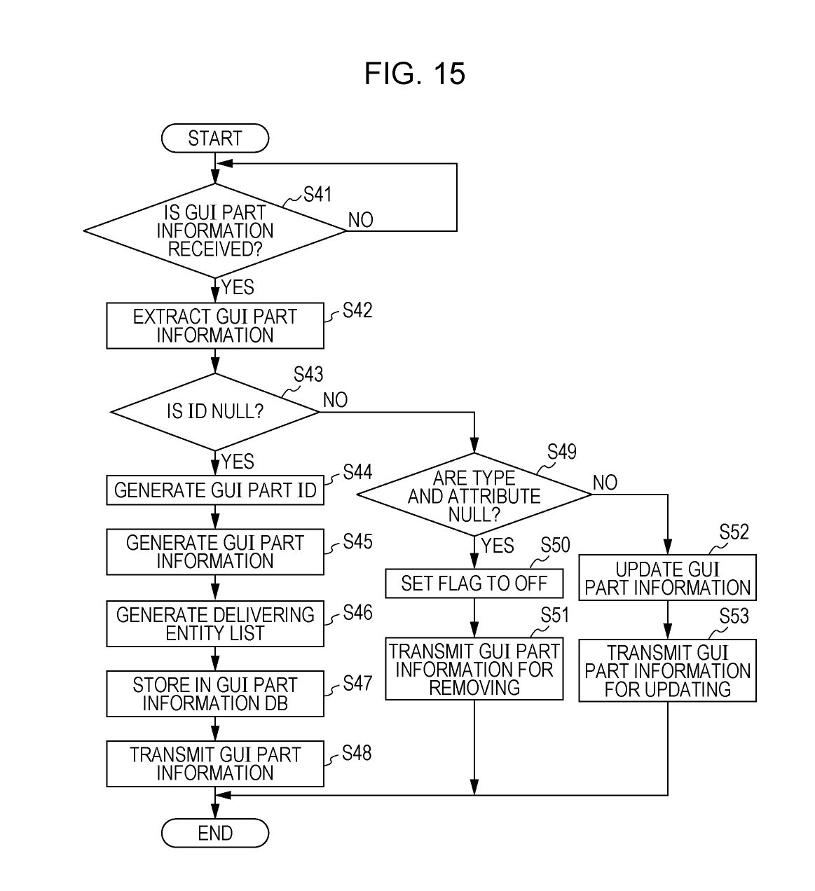

FIG. 12 is a diagram illustrating panel setting information according to an embodiment of the invention.

The panel setting information includes a panel ID, a GUI part type, a GUI part attribute, and a display attribute. The panel ID is a panel ID of a corresponding panel. The GUI part type is a type of a GUI part as an object displayed by the corresponding panel. The GUI part attribute is an attribute of a GUI part, which is necessarily used for the GUI part as an object displayed by the corresponding panel. The display attribute is a form of displaying the GUI part on the corresponding panel.

For example, the panel of which the panel ID is “03” indicates that the GUI part is an application, that the GUI part of which the attribute is an image is displayed, and that the object of the GUI part is displayed in maximum. The panel of which the panel ID is “05” indicates that the GUI part which is a device is displayed and the object of the GUI part is converted to an icon and displayed with the left portion set as a reference (initial position). In addition, with respect to the icon, an image data of the icon may be stored in the client 4 in advance, so that the icon may be displayed by using the image data. Otherwise, the image data together with the GUI part information may be transmitted from the management server 3, so that the icon may be displayed by using the image data.

Next, operations of the conference system 1 are described.

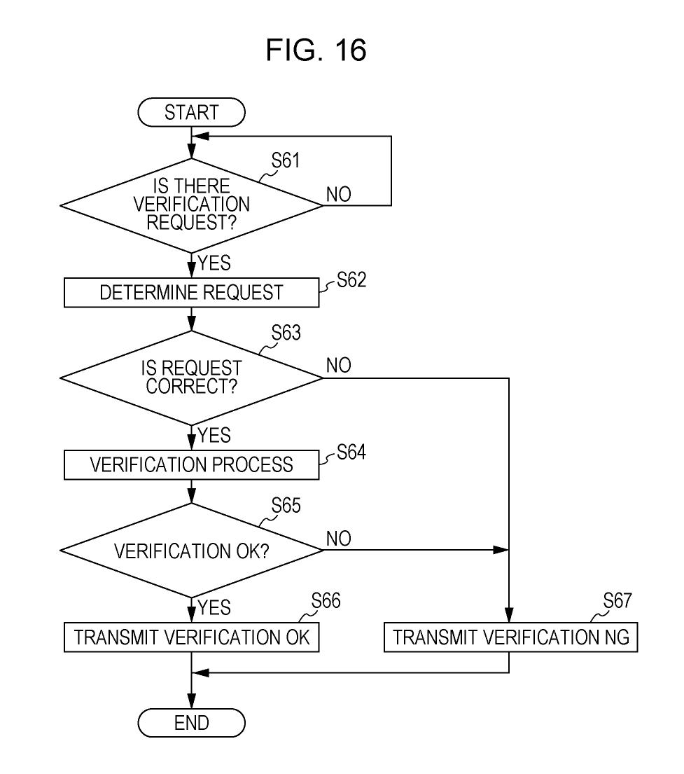

FIG. 13 is a flowchart of a conference participation and GUI display process in a client according to an embodiment of the invention.

In the client 4, if a user inputs registration of conference participation by using an input device, the input processing unit 43 receives the input, and the transceiver 41 transmits a registration request to the conference server 2 (Step S1). Next, the input processing unit 43 determines whether or not to receive the authentication OK from the conference server 2 through the transceiver 41 (Step S2). If the authentication OK is not received, the process ends.

On the other hand, in the case where the authentication OK is received (Step S2: YES), the input processing unit 43 transmits the delivery request for the GUI part information to the management server 3 (Step S3). Next, the input processing unit 43 determines whether or not delivery request OK is received through the transceiver 41 from the management server 3 (Step S4), and in the case where the delivery request OK is not received, the process ends.

On the other hand, in the case where the delivery request OK is received (Step S4: YES), the display processing unit 45 reads the layout information from the layout setting information storage unit 47 (Step S5) and draws the initial screen where the panel is arranged on the screen based on the layout setting information (Step S6).

Next, in the case where there is a delivery of the GUI part information (Step S7: YES), the transceiver 41 receives the GUI part information and transfers to the GUI part information analyzing unit 44 (Step S8).

The GUI part information analyzing unit 44 analyzes the GUI part information (Step S9) and extracts each GUI part information and transmits to the display processing unit 45 (Step S10). At this time, the GUI part information analyzing unit 44 may be configured to acquire the shared data or the application from the access site included in the GUI part information and to transfer to the display processing unit 45. In addition, the GUI part information analyzing unit 44 may be configured to acquire the device driver from the driver supplier for the GUI part information and to install in the client 4. In this manner, the process of acquiring the data (the shared data, the application, and the device driver) from the access site by the GUI part information analyzing unit 44 may be performed in the case where there exists user's indication on the display screen, for example, indication on an icon as an example of the GUI part.

In addition, simultaneously, the display processing unit 45 reads the panel setting information from the panel setting information storage unit 46 (Step S11) and allows the GUI part to be displayed in each panel on the screen based on the GUI part information received from the GUI part information analyzing unit 44 and the panel setting information (Step S12). Therefore, each GUI part is arranged and displayed on the display screen. At this time, for example, if the object of the GUI part is an application, the display processing unit 45 may be configured to acquire the application from the GUI part information analyzing unit 44 and to execute the application. In addition, if the type of the GUI part is a shared data, the display processing unit 45 may be configured to acquire the shared data from the GUI part information analyzing unit 44 and to display the shared data.

Next, the process proceeds to Step S7, and after that, in the case where the GUI part information is delivered (Step S7: YES), the screen display is performed based on the received GUI part information (Steps S8 to S12). For example, in the case where a to-be-added GUI part information is received, the display processing unit 45 or the like newly displays the corresponding GUI part on the screen. In addition, in the case where a to-be-changed GUI part information is received, the GUI part information is changed. In addition, in the case where a to-be-removed GUI part information is received, the display of the corresponding GUI part is removed from the screen.

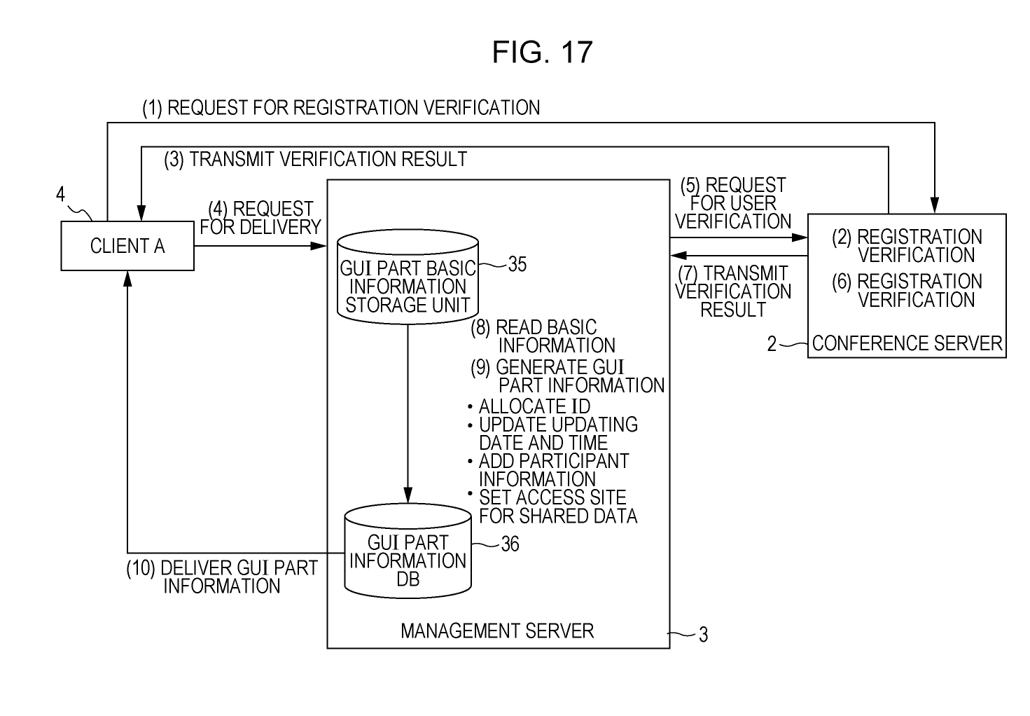

FIG. 14 is a flowchart of a delivery process at the time of participation of a management server according to an embodiment of the invention.

In the management server 3, the subscription management unit 32 determines whether or not the delivery request for the GUI part information is received from the client 4 through the transceiver 31 (Step S21). In the case where the delivery request is not received, the delivery request is waited for. On the other hand, in the case where the delivery request is received (Step S21: YES), the subscription management unit 32 requests the conference server 2 to verify whether or not the user of the client 4 is a user capable of participating in the conference (Step S22).

Next, in the case where the subscription management unit 32 receives a notice of the verification OK from the conference server 2, the subscription management unit 32 transmits a notice indicating the request OK to the client 4 through the transceiver 31 (Step S24).

Next, the subscription management unit 32 determines whether or not the user of the client 4 is a participant who newly participates in a conference (Step S25). In the case of a new participant (Step S25: YES), the GUI part information generating unit 33 reads GUI part basic information from the GUI part basic information storage unit 35 (Step S26), generates the GUI part information based on the GUI part basic information (Step S27), and stores in the GUI part information DB 36. At this time, the GUI part information generating unit 33 allocates GUI part information ID to each GUI part basic information and sets the time point information of the current time to the updating date and time. In addition, the GUI part information generating unit 33 generates the GUI part information indicating the user of the client 4. In addition, the GUI part information generating unit 33 determines and sets the address of the access site for the GUI part information indicating the shared data. Next, the GUI part information generating unit 33 adds the user of the client 4 to the delivering entity list of each GUI part information (excluding the GUI part information indicating the user) (Step S28) and transmits the generated GUI part information (excluding the GUI part information indicating the user) to the client 4 (Step S29). Therefore, basic GUI part information essential to a conference is transmitted.

On the other hand, in the case where the user is not a new participant (Step S25: NO), the GUI part information generating unit 33 generates the GUI part information indicating the user of the client 4 (Step S30) and stores in the GUI part information DB 36. Next, the GUI part information generating unit 33 adds the user of the client 4 to the delivering entity list for the GUI part information excluding the GUI part information indicating the user (Step S31). The GUI part information generating unit 33 transmits to the client 4 of a newly participating user the GUI part information excluding the GUI part information indicating the user and the GUI part information where the flag is set to OFF and transmits to the client 4 of a user who has already participated the GUI part information indicating a newly participating user (Step S32). Therefore, the GUI part information essential to the conference and the GUI part information indicating the user who has already participated in the conference are transmitted to the client 4 of the next participant, and the GUI part information of a newly participating user is transmitted to the user who has already participated.

In addition, in Step S23, in the case where a notice that the verification result is not OK is received, the subscription management unit 32 transmits a notice indicating the request NG to the client 4 through the transceiver 31 (Step S33), and the process returns to Step S21.

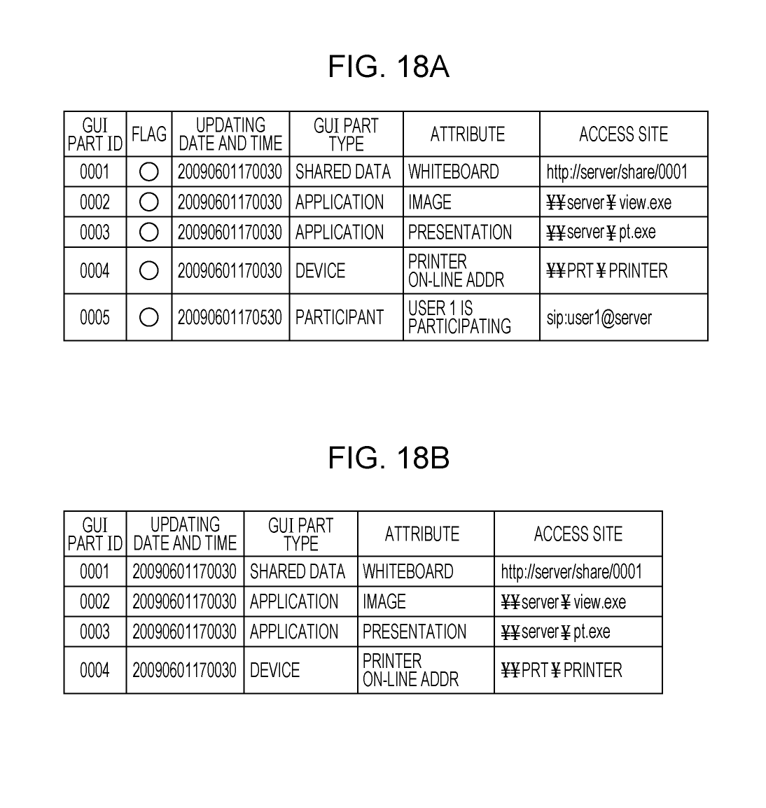

FIG. 15 is a flowchart of a GUI part information transmission management process of the management server 3 according to an embodiment of the invention.

In the management server 3, the GUI part information analyzing unit 34 determines whether or not the GUI part information is received through the transceiver 31 (Step S41). In the case where the GUI part information is not received, the GUI part information is waited for until the GUI part information is received. On the other hand, in the case where the GUI part information is received (Step S41: YES), the GUI part information is extracted (Step S42).

Next, the GUI part information analyzing unit 34 determines whether or not the GUI part ID of the GUI part information is null (Step S43). As a result, in the case where the GUI part ID is null (Step S43: YES), since the GUI part information denotes additional GUI part information indicating addition of the GUI part, the GUI part information generating unit 33 generates the GUI part ID of the GUI part indicated by the GUI part information (Step S44) and sets the GUI part ID as the GUI part information to generate GUI part information for registration (Step S45). The GUI part information generating unit 33 sets all the participating users to the delivering site list for the GUI part information (Step S46) and stores in the GUI part information DB 36 (Step S47). In the embodiment, in Step S25, in the case where the to-be-added GUI part information is a shared data, the GUI part information generating unit 33 acquires an actual entity of the data stored in the access site for the GUI part information from the access site and stores the data in a folder (shared data storage unit) of a shared data stored in a storage unit (not shown) to set the address of the data as new access site to the GUI part information.

Next, the generated GUI part information is transmitted to the client 4 of each of the participating users (Step S48).

On the other hand, in the case where the GUI part ID of the GUI part information is not null (Step S43: NO), the GUI part information analyzing unit 34 determines whether or not the type and the attribute of GUI part information are null (Step S49). As a result, in the case where the type and the attribute are null (Step S49: YES), since the GUI part information denotes the to-be-removed GUI part information indicating the removing of the GUI part, the GUI part information generating unit 33 sets the delivery flag corresponding to the GUI part information to OFF (excludes from the to-be-transmitted objects) and sets the date and time of updating (date and time of removing) the transmitted GUI part information to the updating date and time (Step S50), and the transceiver 31 transmits the GUI part information for removing the GUI part to the client 4 of each user (Step S51). In addition, in the embodiment, although the corresponding GUI part is not allowed to be displayed (allowed to be removed) in the client 4 and is used as a history by controlling the transmission of the GUI part information using the setting of the delivery flag, however, the GUI part information of the GUI part (not shown) which is not allowed to be displayed may be removed from the GUI part information DB 36.

On the other hand, in the case where the type and the attribute are not null (Step S49: NO), since the GUI part information represents the GUI part information for changing, the GUI part information generating unit 33 updates the corresponding GUI part information in the GUI part information DB 36 (for example, updates the updating date and time) (Step S52) and transmits the updated part information for changing to each client 4 (client stored in the corresponding delivering entity list) (Step S53). In addition, in Step S52, in the case where the GUI part information is a shared data, the GUI part information generating unit 33 acquires an actual entity of the data from the access site stored in the access site for the GUI part information and stores the data in a shared data folder.

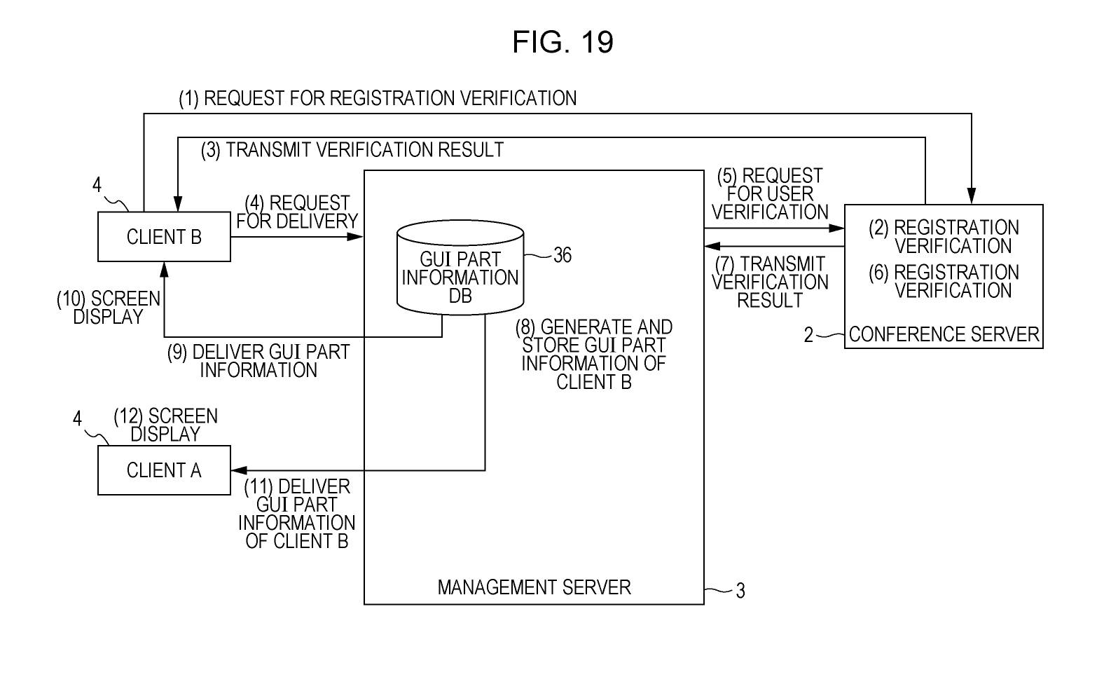

FIG. 16 is a flowchart of a user verification process of the conference server according to an embodiment of the invention.

In the conference server 2, the call controller 22 determines whether or not verification request for a user is received through the transceiver 21 (Step S61). In the case where the verification request is not received, the verification request is waited for until the verification request is received. In addition, the verification request for the user is transmitted from the client 4 or the management server 3.

On the other hand, in the case where the verification request is received (Step S61: YES), it is determined whether or not the request is a correct form (Step S62). As a result, in the case where the request is a correct form (Step S63: YES), the user management unit 23 performs a process of verifying whether or not the user of interest is a user who is permitted to participate in the conference, that is, whether or not the user ID of the user is registered in the user information of the user information DB 24 (Step S64).

As a result, in the case where the result is the verification OK (Step S65: YES), since the user denotes a user whose participation in the conference is permitted, the verification OK is transmitted to the verification requestor apparatus (Step S66). On the other hand, in the case where the request is not a correct form (Step S63: NO) or in the case where the result is not the verification OK (Step S65: NO), the verification NG is transmitted to the verification requestor apparatus (Step S67).

Next, processes between the apparatuses in the conference system 1 are described in detail.

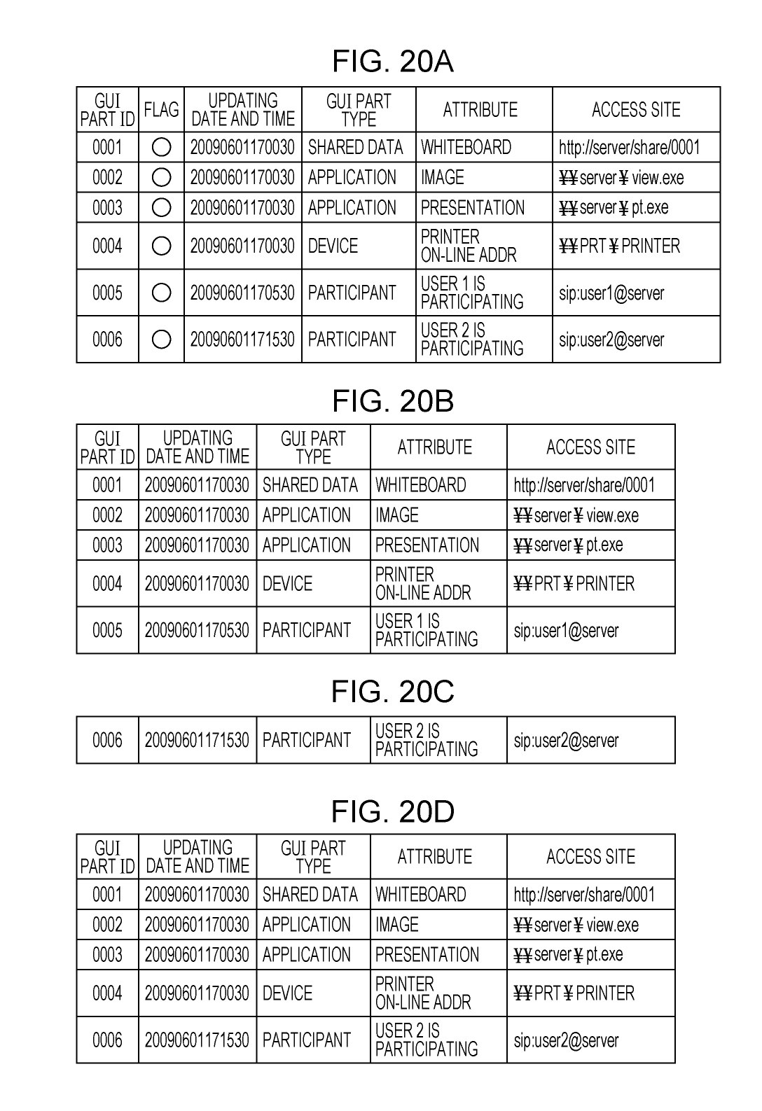

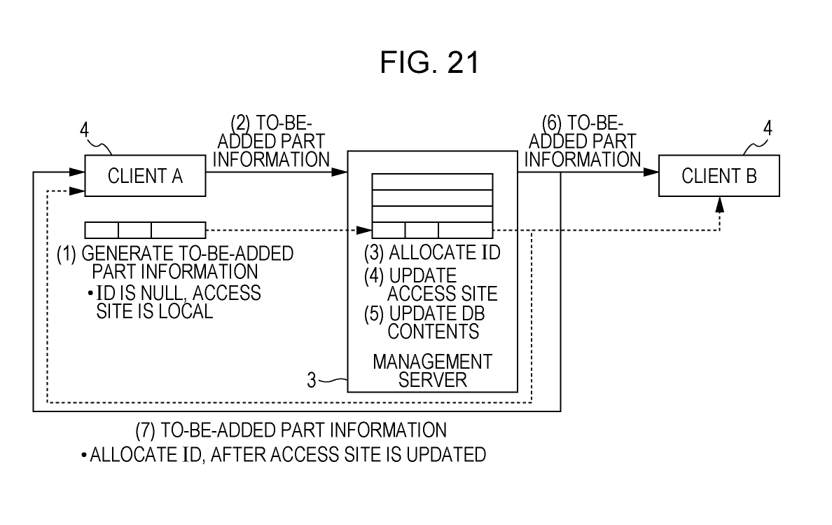

FIG. 17 is a sequence diagram at the time of first user's participation according to an embodiment of the invention. At this time, the client 4 used by the first user (user 1) is defined as a client A. FIGS. 18A and 18B are diagrams illustrating GUI part information at the time of user's participation according to an embodiment of the invention.

First, in the case of receiving an input of conference participation instruction by the user 1, the client A requests the conference server 2 to perform registration verification of the user 1 ((1) of FIG. 17). The conference server 2 performs the registration verification of the user 1 ((2) of FIG. 17) and transmits the verification result to the client 4 ((3) of FIG. 17). As a result, if the verification result is OK, the client A transmits the delivery request for the GUI part information to the management server 3 ((4) of FIG. 17). If the management server 3 receives the delivery request, the management server 3 requests the conference server 2 to perform the verification of the user ((5) of FIG. 17). The conference server 2 performs the registration verification of the user ((6) of FIG. 17) and transmits the verification result to the management server 3 ((7) of FIG. 17). As a result, if the verification result is OK, the GUI part information generating unit 33 of the management server 3 reads the GUI part basic information (in the embodiment, the GUI part basic information illustrated in FIG. 7 is employed as an example to be described later) from the GUI part basic information storage unit 35 ((8) of FIG. 17), generates the GUI part information to register in the GUI part information DB ((9) of FIG. 17). More specifically, the GUI part information generating unit 33 allocates GUI part ID to each GUI part information and sets updating date and time. In addition, the GUI part information generating unit 33 adds the GUI part information (GUI part ID “0005”) of the GUI part indicating the user 1 of the client A. In addition, the GUI part information generating unit 33 sets the access site of the GUI part information (GUI part ID “0001”) of the shared data. As a result, the GUI part information illustrated in FIG. 18A is stored in the GUI part information DB 36. In addition, in FIG. 18A, the transmitting site list of the GUI part information is not illustrated for the convenience of drawing.

Next, the GUI part information (GUI part ID “0005”) of the user 1 is excluded, so that the generated GUI part information is transmitted to the client A ((10) of FIG. 17).

Therefore, the GUI part information illustrated in FIG. 18B is transmitted to and stored in the client A, and the screen is displayed based on the GUI part information.

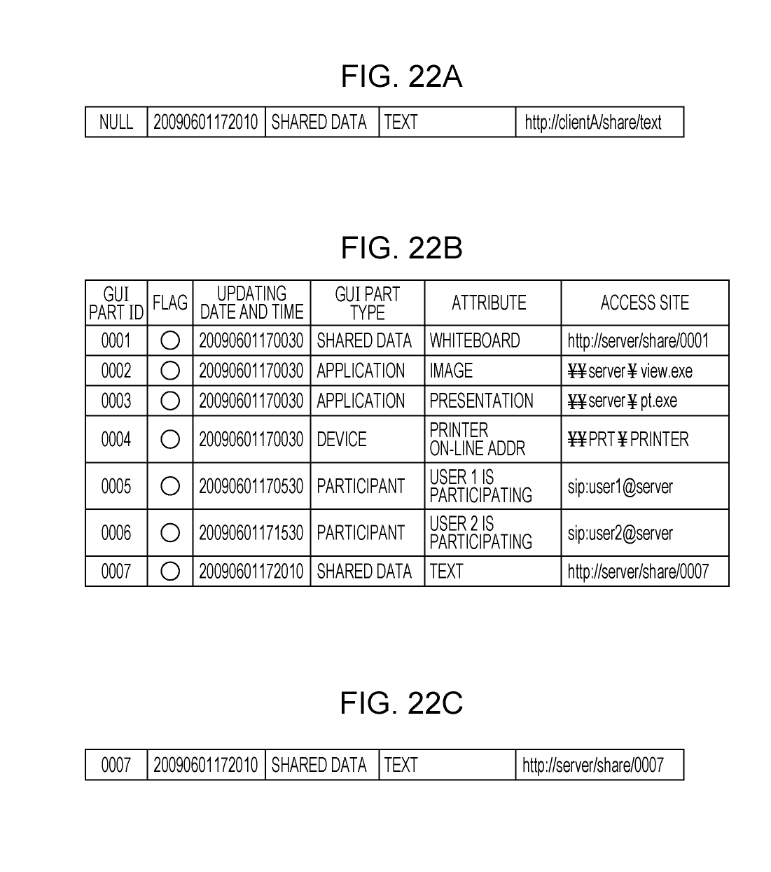

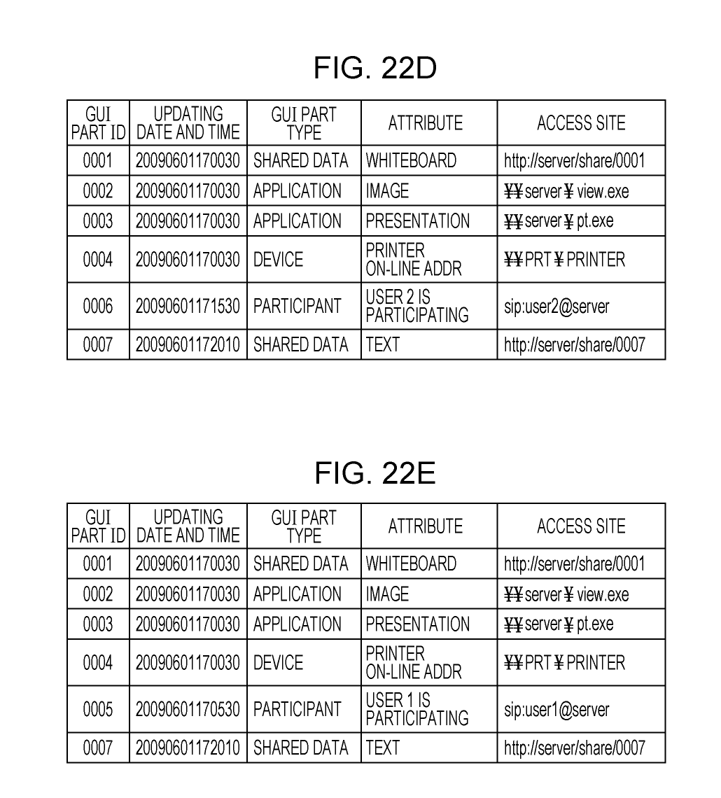

FIG. 19 is a sequence diagram at the time of the next user's participation according to an embodiment of the invention. At this time, the client 4 used by the next user (user 2) is defined as a client B. FIGS. 20A to 20D are diagrams illustrating GUI part information at the time of the next user's participation according to the embodiment of the invention.

In the case of receiving an input of conference participation instruction by the user 2, the client B requests the conference server 2 to perform registration verification of the user 2 ((1) of FIG. 19). The conference server 2 performs the registration verification of the user 2 ((2) of FIG. 19) and transmits the verification result to the client B ((3) of FIG. 19). As a result, if the verification result is OK, the client B transmits the delivery request for the GUI part information to the management server 3 ((4) of FIG. 19). If the management server 3 receives the delivery request, the management server 3 requests the conference server 2 to perform the verification of the user 2 ((5) of FIG. 19). The conference server 2 performs the registration verification of the user 2 ((6) of FIG. 19) and transmits the verification result to the management server 3 ((7) of FIG. 19). As a result, if the verification result is OK, the GUI part information generating unit 33 of the management server 3 generates the GUI part information (GUI part ID “0006”) of the GUI part indicating the user 2 of the client B and adds the GUI part information to the GUI part information DB 36 ((8) of FIG. 19). As a result, in the GUI part information DB 36, as the status illustrated in FIG. 20A, the GUI part information of the GUI part ID “0006” is added to the status illustrated in FIG. 18A.

Next, the GUI part information generating unit 33 transmits to the client B the GUI part information which is other than the GUI part information of the user 2 of the client B in the GUI part information DB 36 and of which the flag is not OFF ((9) of FIG. 19). More specifically, the GUI part information of the GUI part IDs “0001’ to “0005” illustrated in FIG. 20A is transmitted. Therefore, the GUI part information illustrated in FIG. 20B is transmitted to and stored in the client B, and the screen is displayed based on the GUI part information. Accordingly, the screen including the GUI parts indicating the shared data, the image application, the presentation application, the device, and the participant (user 1) is displayed in the client B ((10) of FIG. 19).

Moreover, as illustrated in FIG. 20C, the GUI part information generating unit 33 transmits the GUI part information (GUI part ID “0006”) of the GUI part indicating the user 2 of the client B to a client 4 (in the embodiment, the client A) of a user who has already participated ((11) of FIG. 19). As a result, as illustrated in FIG. 20D, the GUI part information indicating the user 2 of the client B is added to and stored in the client A, and the screen is displayed based on the GUI part information. Therefore, the screen where the GUI part indicating the participant (user 2) is newly added is displayed in the client A ((12) of FIG. 19).

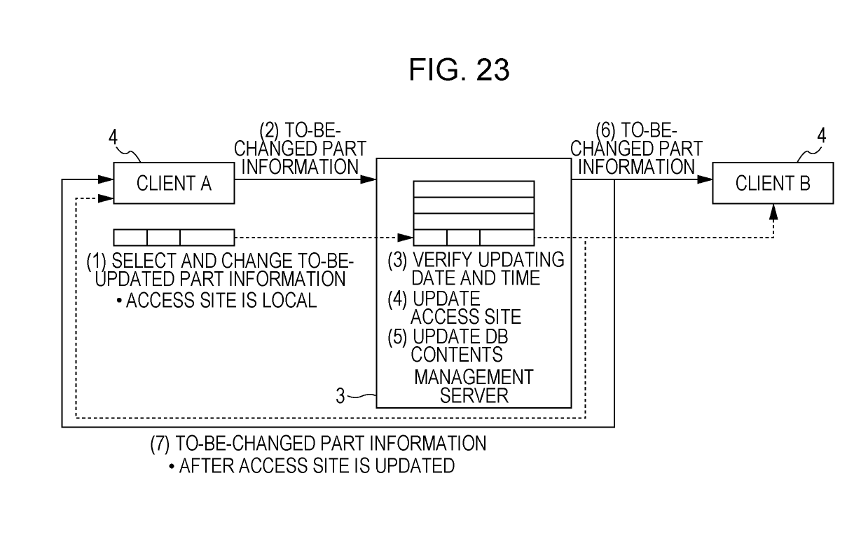

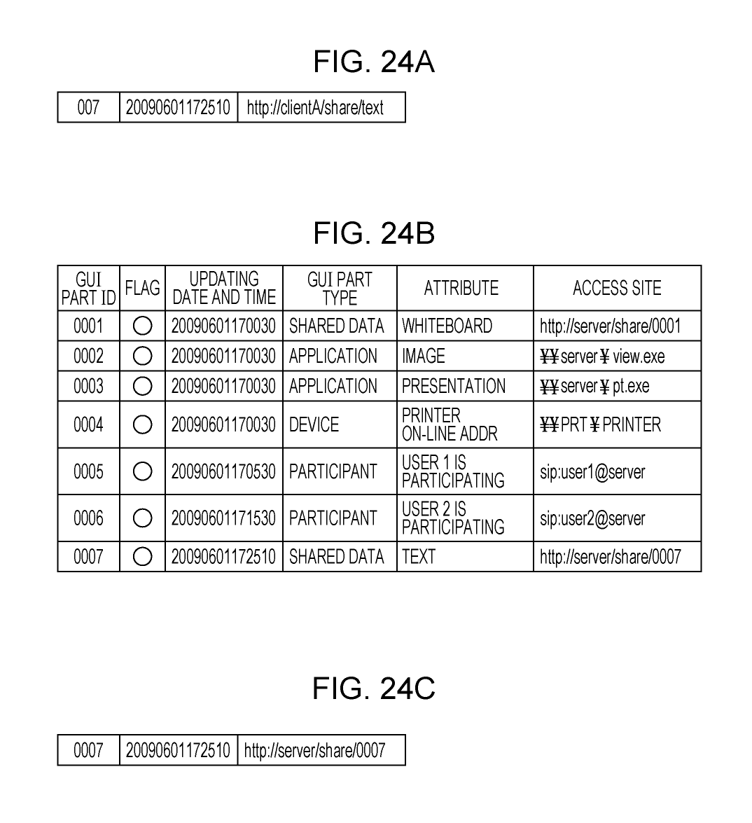

FIG. 21 is a sequence diagram at the time of adding a GUI part according to an embodiment of the invention. FIGS. 22A to 22E are diagrams illustrating GUI part information at the time of adding a GUI part according to an embodiment of the invention.

In the client A, in the case where the input processing unit 43 receives an input of the to-be-newly-added GUI part information from the user 1, the GUI part information generating unit 42 generates the to-be-added GUI part information based on the input ((1) of FIG. 21). As an example, in the case where the GUI part information indicating the shared data is to be added, as illustrated in FIG. 22A, the GUI part information generating unit 42 generates the GUI part information where the GUI part ID is empty (null) and the access site is set with a position of text of the client A where the data as the shared data is stored.

Next, the GUI part information generating unit 42 transmits the generated GUI part information to the management server 3 ((2) of FIG. 21). In the management server 3, since the GUI part ID of the received GUI part information is null, if the GUI part information analyzing unit 34 determines that the GUI part information is a to-be-newly-added GUI part information, the GUI part information generating unit 33 allocates the GUI part ID to the GUI part information ((3) of FIG. 21). In addition, since the part type is a shared data, the GUI part information generating unit 33 receives the corresponding data from the data storage site of the client A corresponding to the access site of the received GUI part information, stores in a shared data folder in the management server 3, and updates the access site into a storage position of the shared folder ((4) of FIG. 21). Next, the GUI part information generating unit 33 adds the GUI part information to the GUI part information DB 36 ((5) of FIG. 21). As a result, in the GUI part information DB 36, as the status illustrated in FIG. 22B, the GUI part information of the GUI part ID “0007” is added to the status illustrated in FIG. 20A.

In addition, the GUI part information generating unit 33 transmits the GUI part information (GUI part ID “0007”) of the added GUI part illustrated in FIG. 22C to the clients 4 of the participating users (in the embodiment, the client A and the client B) ((6) and (7) of FIG. 21).

As a result, as illustrated in FIG. 22D, the GUI part information of the added shared data is added to and stored in the client A, and the screen is displayed based on the GUI part information. Therefore, the screen where the GUI part of the newly added shared data is added is displayed in the client A. In addition, as illustrated in FIG. 22E, the GUI part information of the added shared data is added to and stored in the client B, and the screen is displayed based on the GUI part information. Therefore, the screen where the GUI part of the added shared data is newly added is displayed in the client B.

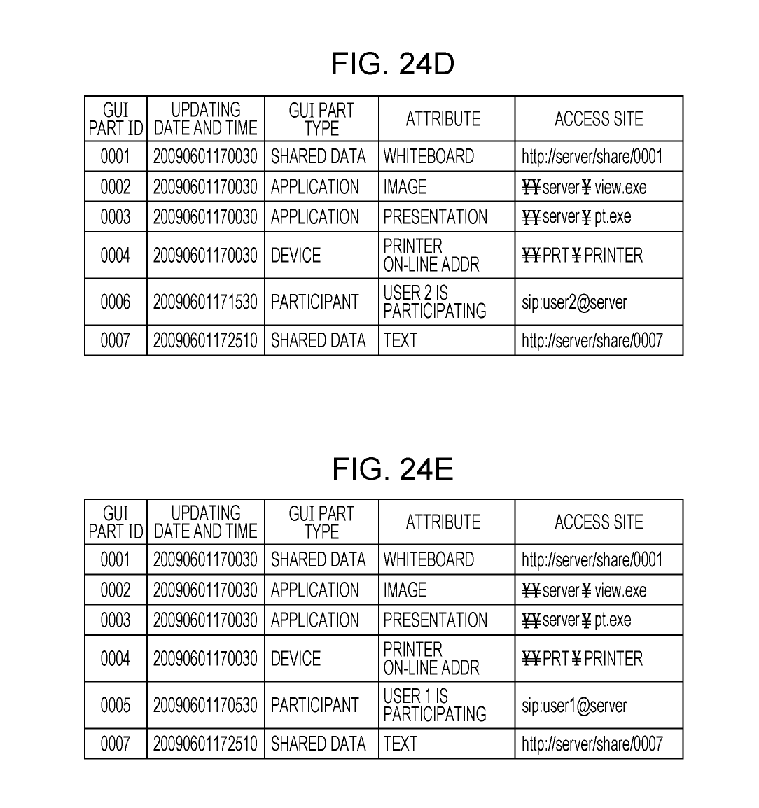

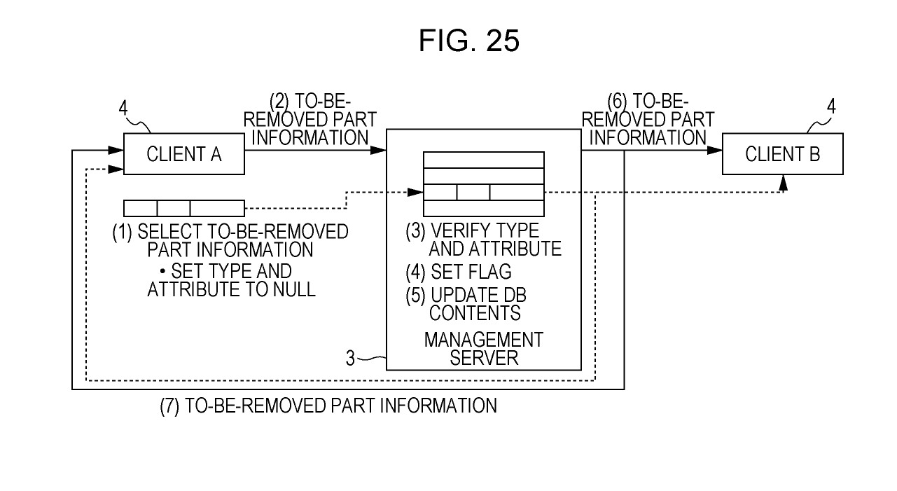

FIG. 23 is a sequence diagram at the time of changing a GUI part according to an embodiment of the invention. FIGS. 24A to 24E are diagrams illustrating GUI part information at the time of changing a GUI part according to an embodiment of the invention. An example of the case where change is performed on the GUI part information added in the sequence illustrated in FIG. 21 is described.

In the client A, in the case where the input processing unit 43 receives an input of selection of the to-be-changed GUI part information and an input of changed contents from the user 1, the GUI part information generating unit 42 generates the changed GUI part information based on the inputs ((1) of FIG. 23). More specifically, as illustrated in FIG. 24A, the GUI part information generating unit 42 generates the GUI part information where the GUI part ID is “0007”, the access site is set to a position of text of the client A where the newly changed data is stored, and the generating date and time is set to the updating date and time. In addition, in the embodiment, with respect to the items not relating to the change in the GUI part information, since it is not included and since the data after change is stored at the position where the data before change is stored, the access site is not changed in comparison with the case where the GUI part information is added.

Next, the GUI part information generating unit 42 transmits the generated GUI part information to the management server 3 ((2) of FIG. 23). In the management server 3, the GUI part information analyzing unit 34 checks the updating date and time of the GUI part information in the GUI part information DB 36 allocated with the GUI part ID “0007” of the received GUI part information ((3) of FIG. 23) and determines that the GUI part information is a to-be-changed GUI part information if the updating date and time is different. If the GUI part information is determined to be a to-be-changed GUI part, the GUI part information generating unit 33 receives the corresponding data from the data storage site of the client A corresponding to the access site of the received GUI part information, stores in a shared data folder in the management server 3, and updates the access site into a storage position of the shared folder ((4) of FIG. 23). Next, the GUI part information generating unit 33 updates the GUI part information DB 36 based on the GUI part information ((5) of FIG. 23). As a result, in the GUI part information DB 36, as the status illustrated in FIG. 24B, the updating date and time of the GUI part ID “0007” are changed in the status illustrated in FIG. 22B.

Moreover, the GUI part information generating unit 33 transmits the GUI part information (GUI part ID “0007”) of the to-be-changed GUI part illustrated in FIG. 24C to clients 4 (in the embodiment, the client A and client B) of the participating users ((6) and (7) of FIG. 23).

As a result, as illustrated in FIG. 24D, in the client A, the GUI part information (GUI part ID “0007”) is changed and stored in a storage unit (part information storage unit) of the client A. Therefore, in the client A, a data is newly acquired from the access site of the GUI part information and stored in the storage apparatus. Accordingly, in the client A, the screen is displayed based on the changed data indicated by the changed GUI part information. In addition, as illustrated in FIG. 24E, the GUI part information (GUI part ID “0007”) is changed and stored in the client B. Therefore, in the client B, a data is newly acquired from the access site of the GUI part information. Accordingly, in the client B, the screen is displayed based on the changed data indicated by the changed GUI part information.

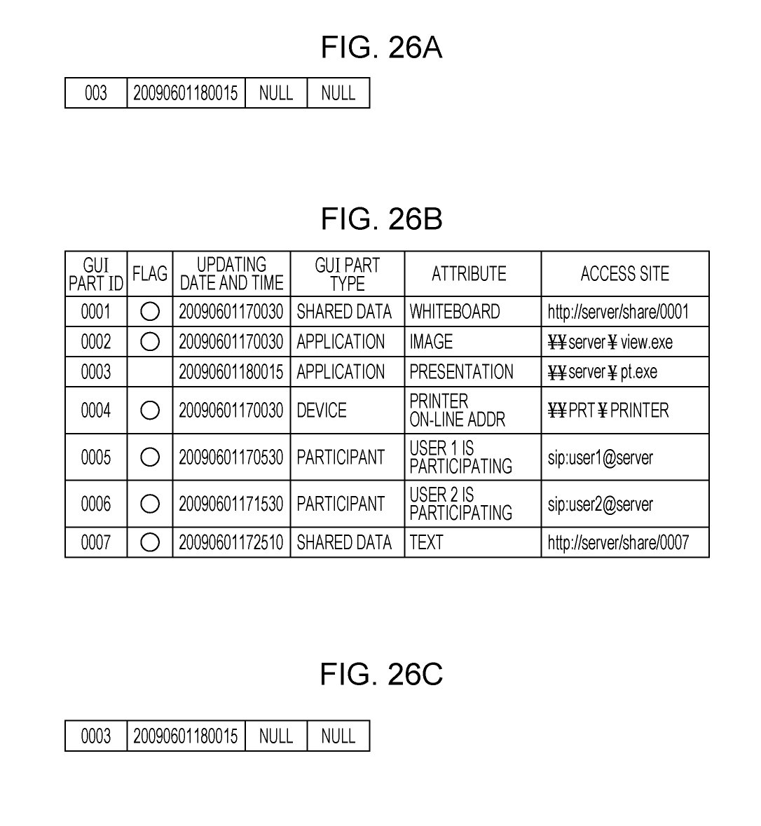

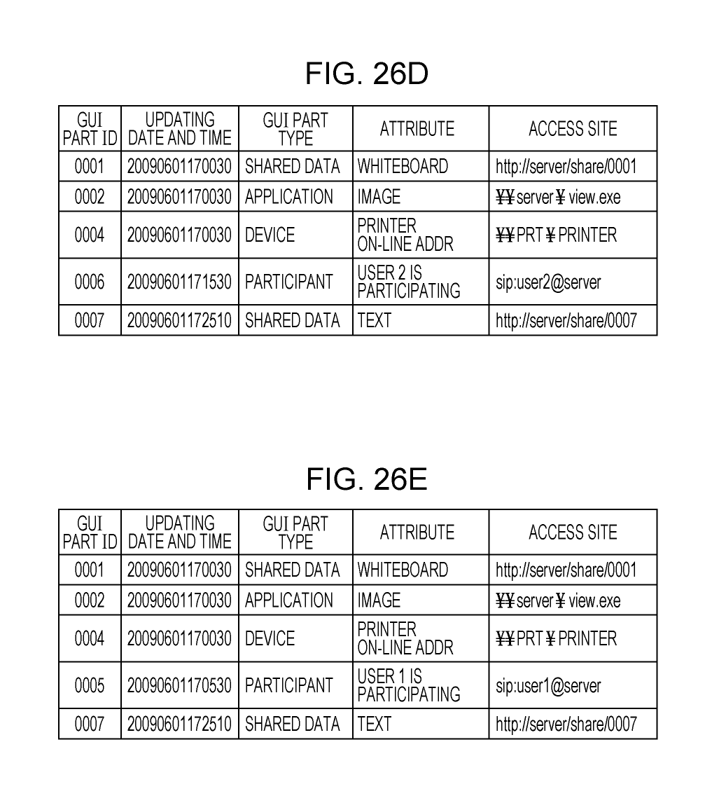

FIG. 25 is a sequence diagram at the time of removing a GUI part according to an embodiment of the invention. FIGS. 26A to 26E are diagrams illustrating GUI part information at the time of removing a GUI part according to an embodiment of the invention.

In the client A, in the case where the input processing unit 43 receives an input of selection of to-be-removed GUI part information from the user 1, the GUI part information generating unit 42 generates the GUI part information that is subjected to the removing based on the input ((1) of FIG. 25). More specifically, as illustrated in FIG. 26A, the GUI part information generating unit 42 generates the GUI part information where the GUI part ID of the selected GUI part information is set, the instructed date and time are set as the updating date and time, and the GUI part type and attribute are null.

Next, the GUI part information generating unit 42 transmits the generated GUI part information to the management server 3 ((2) of FIG. 25). In the management server 3, the GUI part information analyzing unit 34 verifies the GUI part type and the attribute of the received GUI part information ((3) of FIG. 25) and determines that the GUI part is a to-be-removed GUI part since the GUI part type and the attribute thereof are null. If the to-be-removed GUI part is determined, the GUI part information generating unit 33 sets the flag of the GUI part information corresponding to the GUI part ID of the received GUI part information to OFF ((4) of FIG. 25) and updates the updating date and time of the received GUI part information to the updating date and time of the GUI part information corresponding to the GUI part information DB ((5) of FIG. 25). As a result, in the GUI part information DB 36, as the status illustrated in FIG. 26B, the flag and updating date and time of the GUI part ID “0003” are changed in the status illustrated in FIG. 24B.

Furthermore, the GUI part information generating unit 33 transmits the GUI part information of the to-be-removed GUI part illustrated in FIG. 26C to the clients 4 of the participating users (in the embodiment, the client A and the client B) ((6) and (7) of FIG. 25).

As a result, as illustrated in FIG. 26D, the to-be-removed GUI part information (GUI part ID “0003”) is removed from the GUI part information of the client A. Therefore, in the client A, the screen where the corresponding GUI part is removed is displayed. In addition, as illustrated in FIG. 26E, the GUI part information (GUI part ID “0003”) is removed from the GUI part information of the client B. Therefore, in the client B, the screen where the corresponding GUI part is removed is displayed.

Hereinbefore, although the invention is described with reference to the embodiments, the invention is not limited to the aforementioned embodiments, but it may be adapted to various forms.

For example, although the conference server 2 and the management server 3 are configured with different PCs in the aforementioned embodiments, the conference server 2 and the management server 3 may be configured, for example, with one PC. In addition, although the management server 3 and the client 4 are configured with different PCs in the aforementioned embodiments, the management server 3 and one client 4 may be configured, for example, with the same PC.

The entire disclosure of Japanese Patent Application No. 2009-182393, filed Aug. 5, 2009 is expressly incorporated by reference herein.

What is claimed is:

1. A cooperative task supporting system having a plurality of clients, which are to be used by a plurality of users, and a server and supporting a cooperative task of the plurality of users of the plurality of clients,
wherein the server includes:
a part information storage unit which stores part information including attribute information of a predetermined object corresponding to a part, which is to be displayed on a screen of the client of the user participating in the cooperative task, and address information on the object; and
a transmitting unit which transmits the part information to the client of the user participating in the cooperative task, and
wherein the client includes:
a receiving unit which receives the part information; and
a display control unit which allows the part to be displayed on the screen based on the part information.

2. The cooperative task supporting system according to claim 1,
wherein the server further includes a to-be-added part information receiving unit which receives, from the client, to-be-added part information including attribute information and address information corresponding to a to-be-added part, which is to be newly added and displayed on the screen of the client,
wherein the transmitting unit transmits the to-be-added part information to the client of the user participating in the cooperative task,
wherein the receiving unit of the client receives the to-be-added part information, and
wherein the display control unit allows the to-be-added part to be displayed on the screen based on the to-be-added part information.

3. The cooperative task supporting system according to claim 1,
wherein the server further includes a to-be-removed part information receiving unit which receives, from the client, to-be-removed part information specifying a to-be-removed part, which is to be removed from the screen of the client,
wherein the transmitting unit transmits the to-be-removed part information to the client of the user participating in the cooperative task,
wherein the receiving unit of the client receives the to-be-removed part information, and
wherein the display control unit allows the to-be-removed part to be removed from the screen based on the to-be-removed part information.

4. The cooperative task supporting system according to claim 1,
wherein the server further includes a to-be-changed part information receiving unit which receives, from the client, to-be-changed part information indicating an object indicated by a part of the screen of the client is changed,
wherein the transmitting unit transmits the to-be-changed part information to the client of the user participating in the cooperative task,
wherein the receiving unit of the client receives the to-be-changed part information, and
wherein the client further includes:
a client part information storage unit which stores the part information; and
a part information changing unit which updates and stores the part information based on the to-be-changed part information.

5. The cooperative task supporting system according to claim 1,
wherein the client further includes a layout information storage unit which stores layout information specifying a layout position on the screen corresponding to the attribute information indicated by a part, and
wherein the display control unit determines the layout position of the part on the screen based on the attribute information of the part information and the layout information.

6. The cooperative task supporting system according to claim 1,
wherein the client further includes a client side data acquisition unit which accesses an access site corresponding to the address information of the part information to acquire a data from the access site.

7. The cooperative task supporting system according to claim 6,
wherein the object indicated by the part is a data,
wherein the display control unit displays the part information as an icon on the screen, and
wherein the client side data acquisition unit acquires the data from the access site according to indication manipulation on the icon.

8. The cooperative task supporting system according to claim 6,
wherein the server includes:
a server-side data acquisition unit which, in the case where the object indicated by the part information received from the client is a data, acquires the data based on the address information;
a shared data storage unit which stores the acquired data; and
an updating unit which updates the address information of the part information into an address of the data in the shared data storage unit,
wherein the transmitting unit transmits the updated part information to the client of the user participating in the cooperative task, and
wherein, in the case of receiving an access instruction for the part information, the client side data acquisition unit acquires the data from the shared data storage unit of the server indicated by the address information.

9. The cooperative task supporting system according to claim 6,
wherein the object indicated by the part is an application,
wherein the client side data acquisition unit acquires a program data of the application from the access site, and
wherein the client further includes a program execution unit which executes the program data.

10. The cooperative task supporting system according to claim 1,
wherein storage site address information of a storage site storing a driver program of a device of the object is included in the attribute information of the object,
wherein the client includes:
a driver acquisition unit which acquires the driver program of the device based on the storage site address information; and
an installation unit which installs the acquired driver program.

11. A server for supporting a cooperative task, comprising:
a part information storage unit which stores part information including attribute information of a predetermined object corresponding to a part, which is to be displayed on a screen of a client of a user participating in the cooperative task, and address information on the object; and
a transmitting unit which transmits the part information to the client of the user participating in the cooperative task.
